(19) United States
(12) Patent Application Publication
(10) Pub. No.: US 2021/0392687 A1
(43) Pub. Date: Dec. 16, 2021

(54) METHOD, DEVICE AND COMPUTER READABLE MEDIUM FOR PARTIAL SLOT IN NR-U TRANSMISSION

(71) Applicant: NEC CORPORATION, Tokyo (JP)

(72) Inventors: Lin LIANG, Beijing (CN); Gang WANG, Beijing (CN)

(73) Assignee: NEC CORPORATION, Tokyo (JP)

(21) Appl. No.: 17/420,555

(22) PCT Filed: Jan. 7, 2019
(86) PCT No.: PCT/CN2019/070692

§ 371 Date: Jul. 2, 2021

(51) Int. Cl. H04W 74/08; H04W 74/00; H04W 56/00; H04W 72/04; H04L 5/00

(52) U.S. Cl. CPC H04W 74/0816; H04W 74/006; H04L 5/0051; H04W 72/0446; H04W 56/001

(57) ABSTRACT

Embodiments of the disclosure provide a method and device for partial slot in NR-U. According to embodiments of the present disclosure, the network device schedules different types of data channels and the terminal device dynamically monitors the control channel. In this way, transmission resources are saved without introducing additional overheads.

### FIELD OF THE INVENTION

Embodiments of the present disclosure generally relate to communication techniques. More particularly, embodiments of the present disclosure relate to a method, computer-readable medium and device for partial slot in NR-unlicensed (NR-U) transmission.

### BACKGROUND OF THE INVENTION

Communication technologies have been developed in various communication standards to provide a common protocol that enables different wireless devices to communicate on a municipal, national, regional, and even global level. An example of an emerging communication standard is new radio (NR), for example, 5G radio access. NR is a set of enhancements to the Long Term Evolution (LTE) mobile standard promulgated by Third Generation Partnership Project (3GPP). It is designed to better support mobile broadband Internet access by improving spectral efficiency, lowering costs, improving services, making use of new spectrum, and better integrating with other open standards. Further, unlicensed band operations have also been studied and applied in 3GPP. Due to the improvements of NR with respect to LTE, issues regarding NR-U transmission also need to be specified.

### SUMMARY OF THE INVENTION

In general, example embodiments of the present disclosure provide methods, devices and computer-readable media for partial slot in NR-U transmission.

According to a first aspect, embodiments of the present disclosure provide a method performed by a network device. The method comprises: determining whether a data channel to a terminal device is accessible on an unlicensed band. The method further comprises in response to determining that the data channel is accessible, determining, in a time slot, a position of a start symbol of transmission on the data channel. The method also comprises generating, based on the position of the start symbol, a reference signal for the transmission. The method yet comprises transmitting the reference signal on the data channel to the terminal device.

According to a second aspect, embodiments of the present disclosure provide a method performed by a terminal device. The method comprises receiving transmission on a data channel from a network device. The method also comprises obtaining, from the transmission, a reference signal on the data channel, the reference signal being generated based on a position of a start symbol of the transmission in a time slot. The method further comprises demodulating the transmission based on the reference signal.

According to a third aspect, embodiments of the present disclosure provide a method performed by a terminal device. The method comprises monitoring control information on a control channel from a network device at a first predetermined period. The method further comprise in response to successfully detecting the control information, monitoring further control information on the control channel at a second predetermined period. The second predetermined period is longer than the first predetermined period.

According to a fourth aspect, embodiments of the disclosure provide a network device. The network device comprises: at least one controller; a memory coupled to the at least one controller, the memory storing instructions therein, the instructions, when executed by the at least one controller, causing the network device to perform acts including: determining whether a data channel to a terminal device is accessible on an unlicensed band; in response to determining that the data channel is accessible, determining, in a time slot, a position of a start symbol of transmission on the data channel; generating, based on the position of the start symbol, a reference signal for the transmission; and transmitting the reference signal on the data channel to the terminal device.

According to a fifth aspect of embodiments of the present disclosure, embodiments of the disclosure provide a terminal device. The terminal device comprises: at least one controller; a memory coupled to the at least one controller, the memory storing instructions therein, the instructions, when executed by the at least one controller, causing the terminal device to perform acts including: receiving transmission on a data channel from a network device; obtaining, from the transmission, a reference signal on the data channel, the reference signal being generated based on a position of a start symbol of the transmission in a time slot; and demodulating the transmission based on the reference signal.

According to a sixth aspect of embodiments of the present disclosure, embodiments of the disclosure provide a terminal device. The terminal device comprises: at least one controller; a memory coupled to the at least one controller, the memory storing instructions therein, the instructions, when executed by the at least one controller, causing the terminal device to perform acts including: monitoring control information on a control channel from a network device at a first predetermined period;

and in response to successfully detecting the control information, monitoring further control information on the control channel at a second predetermined period, the second predetermined period being longer than the first predetermined period.

According to a seventh aspect of embodiments of the present disclosure, embodiments of the disclosure provide a computer readable medium. The computer readable medium storing instructions thereon, the instructions, when executed by at least one processing unit of a machine, causing the machine to perform the method according to the first, second or third aspects.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 shows a schematic diagram of some examples of mini slots according to conventional solutions;

FIG. 2 shows a schematic diagram of some examples for slot duration according to conventional solutions;

FIG. 3 shows a schematic diagram of some examples of mini slots according to conventional solutions;

FIG. 4 shows a schematic diagram of some examples of slots according to conventional solutions;

FIG. 5 illustrates a schematic diagram of a communication system where embodiments of the present disclosure can be applied;

FIG. 6 illustrates a schematic diagram of interactions between the network device and the terminal device according to some embodiments of the present disclosure;

FIG. 7 illustrates a schematic diagram of partial slots according to embodiments of the present disclosure;

FIG. 8 illustrates a schematic diagram of interactions between the network device and the terminal device according to some embodiments of the present disclosure;

FIG. 9 illustrates a schematic diagram of partial slots according to embodiments of the present disclosure;

FIG. 10 illustrates a flowchart of a method implemented at the network device according to embodiments of the present disclosure;

FIG. 11 illustrates a flowchart of a method implemented at the terminal device according to embodiments of the present disclosure;

FIG. 12 illustrates a flowchart of a method implemented at the terminal device according to embodiments of the present disclosure; and

FIG. 13 is a simplified block diagram of a device that is suitable for implementing embodiments of the present disclosure.

Throughout the drawings, the same or similar reference numerals represent the same or similar element.

### DETAILED DESCRIPTION OF EMBODIMENTS

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” or “base station” (BS) refers to a device which is capable of providing or hosting a cell or coverage where terminal devices can communicate. Examples of a network device include, but not limited to, a Node B (NodeB or NB), an Evolved NodeB (eNodeB or eNB), a NodeB in new radio access (gNB) a Remote Radio Unit (RRU), a radio head (RH), a remote radio head (RRH), a low power node such as a femto node, a pico node, and the like. For the purpose of discussion, in the following, some embodiments will be described with reference to gNB as examples of the network device.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, image capture devices such as digital cameras, gaming devices, music storage and playback appliances, or Internet appliances enabling wireless or wired Internet access and browsing and the like.

The term “time slot” used herein refers to a duration of time. For example, in NR, one time slot comprise 14 OFDM symbols.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the Figures. For example, two functions or acts shown in succession may in fact be executed concurrently or may sometimes be executed in the reverse order, depending upon the functionality/acts involved.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), New Radio (NR) Access and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future.

Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

The term “network device” includes, but not limited to, a base station (BS), a gateway, a management entity, and other suitable device in a communication system. The term “base station” or “BS” represents a node B (NodeB or NB), an evolved NodeB (eNodeB or eNB), a next generation NodeB (gNB), a Remote Radio Unit (RRU), a radio header (RH), a remote radio head (RRH), a relay, a low power node such as a femto, a pico, and so forth.

The term “terminal device” includes, but not limited to, “user equipment (UE)” and other suitable end device capable of communicating with the network device. By way of example, the “terminal device” may refer to a terminal, a Mobile Terminal (MT), a Subscriber Station (SS), a Portable Subscriber Station, a Mobile Station (MS), or an Access Terminal (AT).

As mentioned above, issues regarding NR-unlicensed (NR-U) transmissions also need to be specified. In conventional technologies, physical downlink shared channel (PDSCH) transmission which is scheduled based on the physical downlink control channel (PDCCH) may be transmitting at predefined certain occasions, for example, at the slot boundaries. However, if the PDSCH only accesses at slot boundaries, the access ability may be low. If the PDSCH can access at any time, it may have other problems. For example, it needs reservation signals which are between the start of successful listen-before-talk (LBT) transmission and the start of real transmission. The reservation signals may not include useful information, thereby wasting transmission resources. Further, whether the LBT is successful may be determined immediately before the transmission, the network device may not have enough time to change or adjust transmitted signal.

In recent 3GPP proposals, it has been identified to be beneficial for the NR-U design to not require the gNB to change a pre-determined transport block size (TBS) for a PDSCH transmission depending on the LBT outcome, at least when the PDSCH is transmitted at the beginning of the gNB's channel occupancy time (COT). Further, the following options have been identified as possible candidates for PDSCH transmission in the partial slot at least for the first PDSCH(s) transmitted in the DL transmission burst: Option 1: PDSCH(s) as in Rel-15 NR; Option 2: Punctured PDSCH depending on LBT outcome; Option 3: PDSCH mapping type B with durations other than 2/4/7 symbols; Option 4: PDSCH across slot boundary.

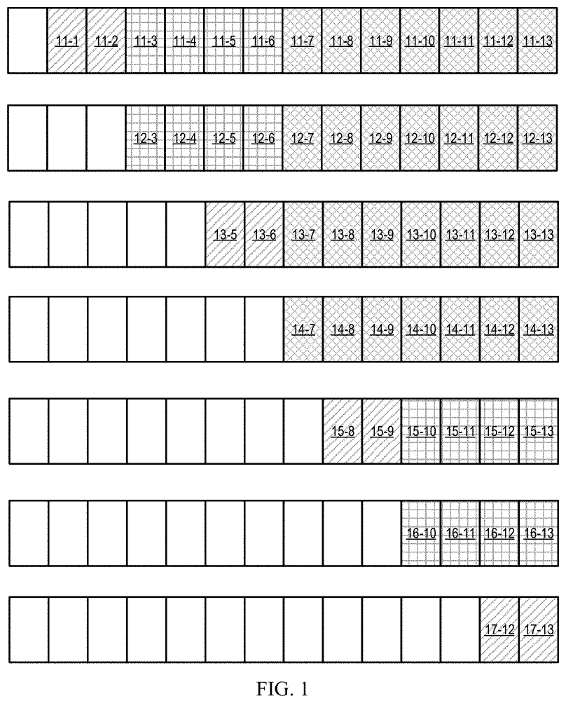

PDSCH mapping types supported in NR Release 15 provide enough flexibility for PDSCH transmission in the partial slot at least for the first PDSCH(s) transmitted in the DL transmission burst. FIG. 1 illustrates some examples of mini slots according to conventional technologies. As shown in FIG. 1, there are three kinds of mini slots, 2 symbol mini slot, 4 symbol mini-slot, and 7 symbol mini-slot. If the start symbol is the symbol 11-, there three kinds of mini-slot for the following symbol. Symbols 11-1 and 11-2 compose the 2 symbol mini-slot. Symbols 11-3, 11-4 and 11-5 compose the 4 symbol mini-slot. Symbols 11-7, 11-8, 11-9, 11-10, 11-11, 11-12 and 11-13 compose the 7 symbol mini-slot.

Similarly, if the start symbol is the symbol 12-3, the symbols 12-3, 12-4, 12-5 and 12-6 compose the 4 symbol mini-slot and the symbols 12-7, 12-8, 12-9, 12-10, 12-11, 12-12 and 12-13 compose the 7 symbol mini-slot. If the start symbol is the symbol 13-5, the symbols 13-5 and 13-6 compose the 2 symbol mini-slot and the symbols 13-7, 13-8, 13-9, 13-10, 13-11, 13-12 and 13-13 compose the 7 symbol mini-slot. If the start symbol is the symbol 14-7, the symbols 14-7, 14-8, 14-9, 14-10, 14-11, 14-12 and 14-13 compose the 7 symbol mini-slot. If the start symbol is the symbol 15-8, the symbols 15-8 and 15-9 compose the 2 symbol mini-slot and the symbols 15-10, 15-11, 15-12 and 15-13 compose the 4 symbol mini-slot. If the start symbol is the symbol 16-10, the symbols 16-10, 16-11, 16-12 and 16-13 compose the 4 symbol mini-slot. If the start symbol is the symbol 17-12, the symbols 17-12 and 17-13 compose the 2 symbol mini-slot.

However, the cost in base stations increases due to the mini slots. Further, the technology of mini slots requires more reference signals, thereby increasing ratio of pilot signals and overheads.

FIG. 2 shows some examples for slot duration according to conventional solutions. As shown in FIG. 2, to fit in initial slot with starting position other than symbol #0, starting symbols of PDSCH(s) may be shifted by the offset between symbol #0 and the obtained starting position according to the LBT procedure, and the overflushed part(s) of the PDSCH(s) are punctured. However, it is not easy to be compatible with the standards.

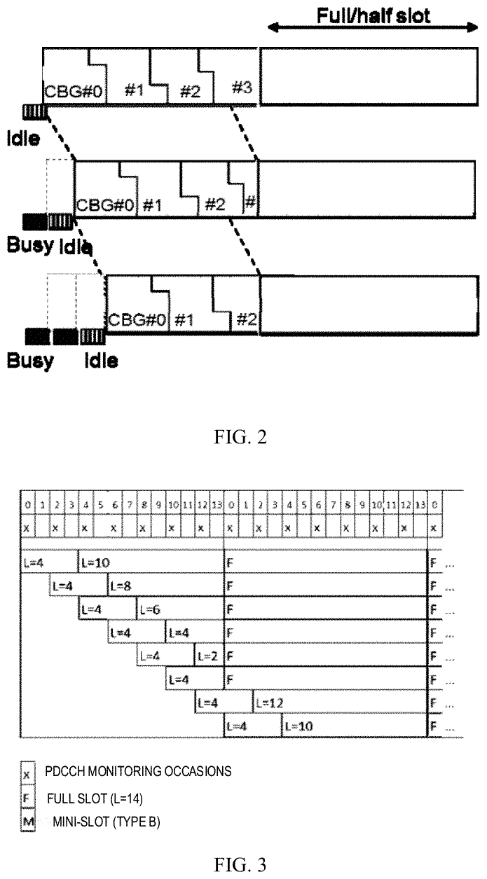

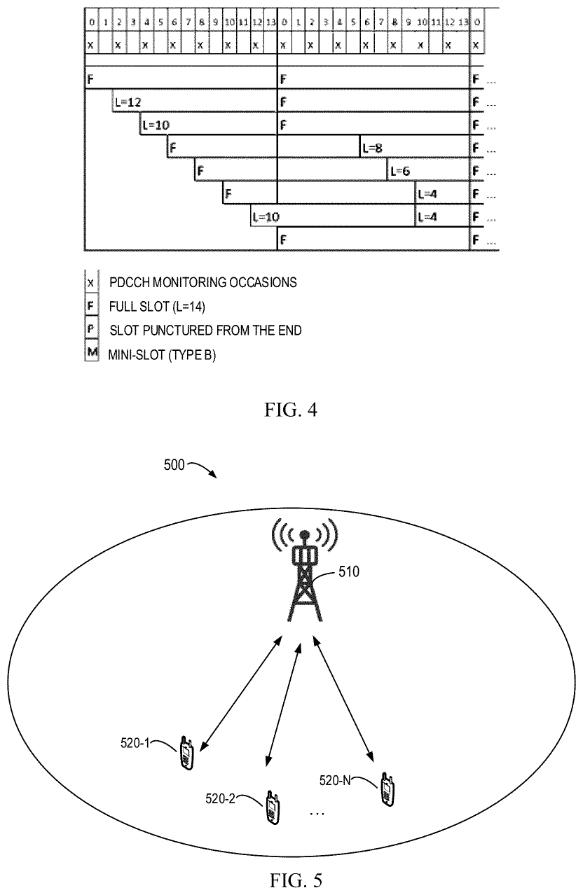

FIGS. 3 and 4 show some examples of slots according to conventional solutions, respectively. As shown in FIGS. 3 and 4, if the start symbol of the transmission is not at the time slot boundary, for example at the second symbol, the last symbol of the transmission may be punctured. However, it is not easy to be compatible with the standards either.

In some conventional technologies, the time-varying parameters of l and n are removed. However, it may reduce the ability of anti-interferences. Further, in some conventional technologies, the parameter l (OFDM symbol number within the slot) is determined relative to the control channel starting symbol of the search space set associated with the CORESET and the parameter n (slot number within a frame) is determined relative to the starting symbol of the COT. However, it needs much more accuracy to detect the starting symbol of the COT correctly.

In order to solve the above and other potential problems, embodiments of the present disclosure provide solutions for partial slots in NR-U. According to embodiments of the present disclosure, the network device schedules different types of data channels and the terminal device dynamically monitors the control channel. In this way, transmission resources are saved without introducing additional overheads.

FIG. 5 shows an example communication network 500 in which embodiments of the present disclosure can be implemented. The network 500 includes a network device 510, and terminal devices 520-1, 520-2, . . . . , 520-N (collectively referred to as “terminal devices 520” hereafter), where N is an integer number. It is to be understood that the number of network devices and terminal devices is only for the purpose of illustration without suggesting any limitations. The network 100 may include any suitable number of network devices and terminal devices adapted for implementing embodiments of the present disclosure.

In the communication network 500, the network device 510 can communicate data and control information to the terminal devices 520, and the terminal devices 520 can also communication data and control information to the network device 510. A link from the network device 510 to the terminal devices 520 is referred to as a downlink (DL) or a forward link, while a link from the terminal devices 520 to the network device 510 is referred to as an uplink (UL) or a reverse link.

Depending on the communication technologies, the network 500 may be a Code Division Multiple Access (CDMA) network, a Time Division Multiple Address (TDMA) network, a Frequency Division Multiple Access (FDMA) network, an Orthogonal Frequency-Division Multiple Access (OFDMA) network, a Single Carrier-Frequency Division Multiple Access (SC-FDMA) network or any others. Communications discussed in the network 100 may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols. The techniques described herein may be used for the wireless networks and radio technologies mentioned above as well as other wireless networks and radio technologies. For clarity, certain aspects of the techniques are described below for LTE, and LTE terminology is used in much of the description below.

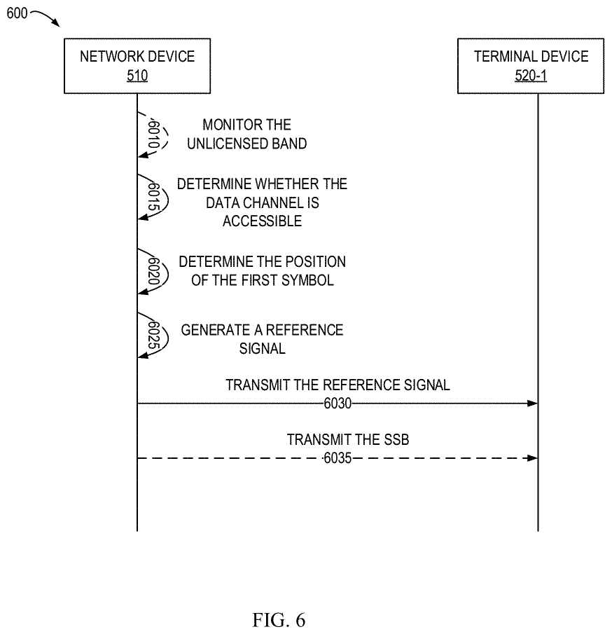

Now implementations of the present disclosure will be described in detail below with reference to FIGS. 6-12. FIG. 6 illustrates a schematic diagram of interaction 600 in accordance with embodiments of the present disclosure. Only for the purpose of discussion, the interaction 600 will be described with reference to FIG. 5 as performed among the terminal device 520-1 and the network device 510.

In some embodiments, the network device 510 may monitor 6010 the unlicensed band. For example, the network device 510 may perform LBT on the unlicensed band. The network device determines 6015 whether the data channel is accessible on the unlicensed band. For example, the network device may determine that the data channel is accessible on the unlicensed band based on the result of the LBT. For example, the data channel may be a PDSCH. It should be noted that the data channel may be other suitable channels.

The network device 510 determines 6020 the position of the start symbol of the transmission on the data channel. The network device 510 generates 6025 a reference signal based on the position of the start symbol. For example, the reference signal may be a demodulation reference signal (DMRS). In some embodiments, the reference signal may be generated based on the following formula (1).

$${c}_{i n i t} = ( {2}^{17} ( {N}_{symb}^{slot} {n}_{s , f}^{μ} + l + 1 ) ( 2 {N}_{I D}^{{n}_{SCID}} + 1 ) + 2 {N}_{I D}^{{n}_{SCID}} + {n}_{S C I D} ) mod {2}^{31} \qquad ( 1 )$$

where l is the OFDM symbol index within the time slot, n_{s,f}^{μ} is the slot index within a frame, and N_{ID}⁰, N_{ID}¹∈{0,1, . . . ,65535} are given by the higher-layer parameters scramblingID0 and scramblingID1, respectively, in the DMRS-DownlinkConfig IE if provided and the PDSCH is scheduled by PDCCH using DCI format 1_1 with the CRC scrambled by C-RNTI, MCS-C-RNTI, or CS-RNTI; N_{ID}⁰∈{0,1, . . . , 65535} is given by the higher-layer parameter scramblingID0 in the DMRS-DownlinkConfig IE if provided and the PDSCH is scheduled by PDCCH using DCI format 1_0 with the CRC scrambled by C-RNTI, MCS-C-RNTI, or CS-RNTI; N_{ID}ⁿ^{_{SCID}}=N_{ID}^{cell} otherwise. The quantity n_{SCID}∈{0, 1} is given by the DM-RS sequence initialization field, in the DCI associated with the PDSCH transmission if DCI format 1_1 is used, otherwise n_{SCID}=0.

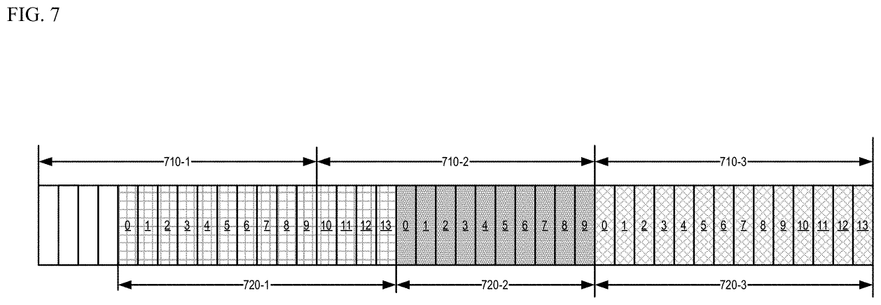

Detailed descriptions will be with reference to FIG. 7 which illustrates a schematic diagram of partial slots according to embodiments of the present disclosure.

The network device 510 may determine that the start symbol of the transmission is not at the boundary of the time slot. As shown in FIG. 7, the start symbol of the transmission 720-1 on the data channel is within the time slot 710-1, which means the transmission 720-1 does not start at the time slot boundary. The transmission 720-1 may comprise 14 symbols, 10 symbols in the time slot 710-1 and 4 symbols in the time slot 710-2. The sequence of reference signal may be generated based on the index of the time slot 710-1 and the relative indexes of the symbols. The symbol position of reference signal may also be generated based on the index of the time slot 710-1 and the relative indexes of the symbols. The term “relative index” used herein indicates a position of one symbol being in the symbols of the transmission. For example, the actual index of the symbols in the transmission 720-1 may be “4”, “5”, “6”, “7”, “8”, “9”, “10”, “11”, “12” and “13” in the time slot 710-1 and “0”, “1”, “2” and “3” in the time slot 710-1. The relative indexes are “0”, “1”, “2”, “3”, “4”, “5”, “6”, “7”, “8”, “9”, “10”, “11”, “12” and “13.” The start length indication value (SLIV) in downlink control information may also be based on the relative indexes of the symbols.

The transmission 720-1 extends on the time slots 710-1 and 710-2. The reference signal for the transmission 720-1 may be generated based on the index of the time slot which the start symbol belongs to, that is to say, the index of the time slot 710-1. For the data channel ratematching with CORESET in stage 1 which the start symbol of PDSCH is not at slot boundary, the first CORESET in data channel is counted. The rest search spaces are ignored. That means the rate matching pattern of PDSCH is related to relative symbol indexes of PDSCH in stage 1.

The network device 510 may determine the number of symbols in the transmission 720-2 based on the transmission 720-1. By way of example, as shown in FIG. 7, the transmission 720-1 uses 4 symbols in the time slot 710-2 and 10 symbols are left in the time slot 710-2, the network device 510 may determine the number of symbols in the transmission 720-2 is 10. The reference signal for the transmission 720-2 may be generated based on the index of the time slot 710-2 and the relative indexes of the symbols. The relative indexes are “0”, “1”, “2”, “3”, “4”, “5”, “6”, “7”, “8”, “9” and “10.” In this way, the data channel can be scheduled more flexibly. Further, it prevents wasting resource.

The network device 510 may determine that the start symbol of the transmission is at the boundary of the time slot. As shown in FIG. 7, the start symbol of the transmission 720-3 on the data channel is at the boundary of the time slot 710-3. The reference signal may be generated based on the index of the time slot 710-3 and the actual indexes of the symbols. Since the transmission 720-3 starts at the first symbol of the time slot 710-3, the actual indexes are “0”, “1”, “2”, “3”, “4”, “5”, “6”, “7”, “8”, “9”, “10”, “11”, “12” and “13.”

Referring back to FIG. 6. The network device 510 transmits 6030 the reference signal on the data channel. Optionally, in some embodiments, the network device 510 may transmit 6035 synchronization signal block (SSB) on the data channel. For slot where the data channel can transmit with SSB simultaneously, the control channel occasion may be compatible with SSB transmission, that is, do not change rate match of the data channel. For 15 KHz SCS as example, the monitor frequency in these slots should be 0.5 ms (7 symbols) that PDSCH do not need changing its rate match. The monitor frequency not in these slots can be more frequent, e.g. 2 symbols. For cross carrier scheduling, if cross carrier data channel is failed to transmit at the indicated start symbol, the data channel will not transmit.

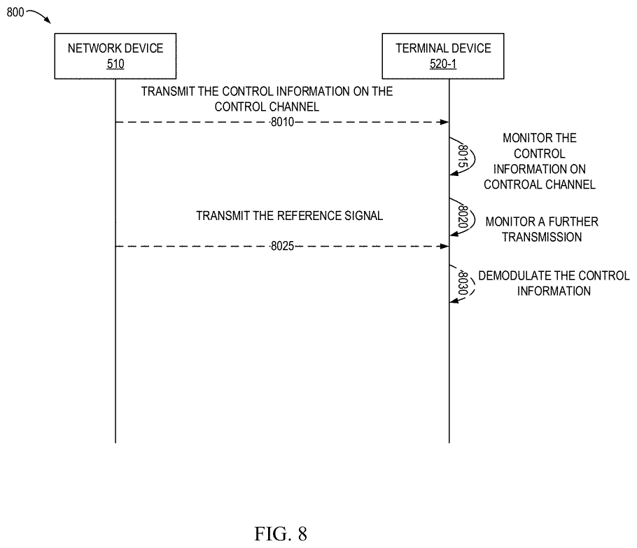

FIG. 8 illustrates a schematic diagram of interaction 800 in accordance with embodiments of the present disclosure. Only for the purpose of discussion, the interaction 800 will be described with reference to FIG. 5 as performed among the terminal device 520-1 and the network device 510.

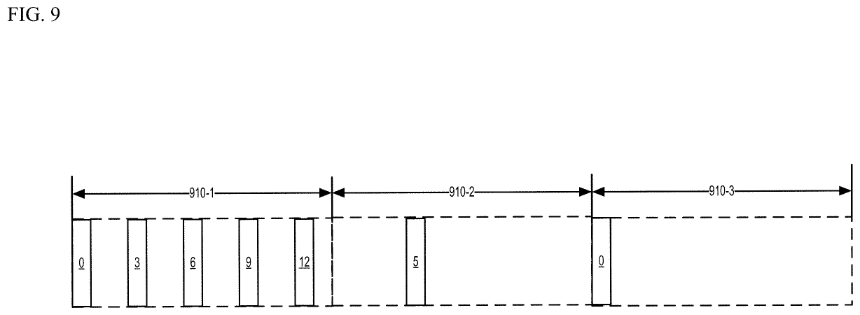

The network device 510 may transmit 8010 control information on the control channel to the terminal device 520-1. The terminal device 520-1 monitors 8015 the control information on the control channel at a first predetermined period. If the terminal device 520-1 successfully detects the control information at a first predetermined period and the OFDM symbols containing DCI is at slot boundary, the terminal device 520-1 monitor's 8020 further control information at a second predetermined period which is longer than the first predetermined periods. Detailed descriptions will be with reference to FIG. 9 which illustrates a schematic diagram of partial slots according to embodiments of the present disclosure.

As shown in FIG. 9, at the beginning, the terminal device 520-1 may monitor the control information more frequently. For example, the terminal device 520-1 may monitor the control information at symbols 0, 3, 6, 9 and 12 in the time slot 910-1. After the terminal device 520-1 detects the control information on the control channel, the terminal device 520-1 may monitor the further control information less frequently. For example, if the terminal device 520-1 detects the control information on the control channel and the control channel is at the time slot boundary, the terminal device 520-1 may monitor the further control information at symbol 0 in the time slot 910-3. In this way, the energy of the terminal device 520-1 can be saved.

In some embodiments, as shown in FIG. 9, if the terminal device 520-1 detects the control information and the control channel is not at the time slot boundary, the terminal device 520-1 may monitor the further control information based on data channel scheduling information. In some embodiments, the terminal device 520-1 may monitor the further control information at the end of the data channel. In some embodiments, if it is the first time that detected common DCI is not at slot boundary, the terminal device 520-1 may monitor the further control information at the predetermined symbol which (e.g. 14 symbols, i.e. the same value as the second predetermined period, after the first OFDM symbol containing DCI) once it detects common DCI which is not transmitted at slot boundary. And if it is not the first time that detected common DCI is not at slot boundary, the terminal device 520-1 may monitor the further control information at the next slot boundary.

Referring back to FIG. 8. The network device 510 may transmit 8025 the reference signal to the terminal device 520-1. The reference signal may be generated based on the index of the time slot which the control channel is within. The terminal device 520-1 may demodulate 8030 the control information based on the reference signal.

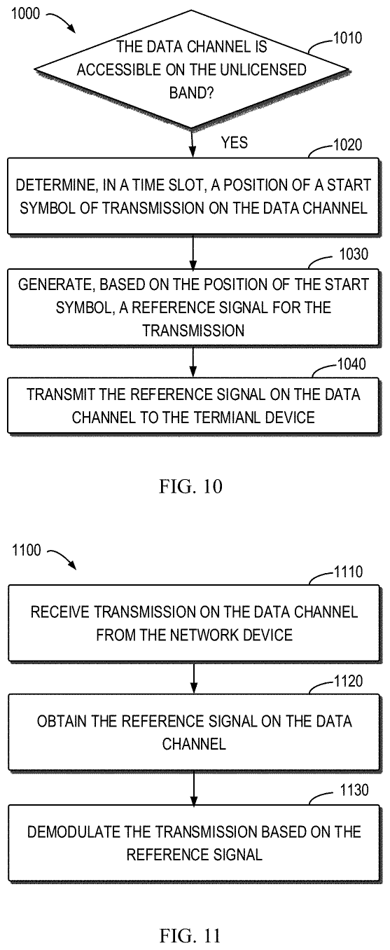

FIG. 10 illustrates a flowchart of an example method 1000 in accordance with embodiments of the present disclosure. It is to be understood that the method 1000 may include additional blocks not shown and/or may omit some blocks as shown, and the scope of the present disclosure is not limited in this regard. The method 1000 can be implemented at a network device, such as the network device 510 as shown in FIG. 5. Additionally or alternatively, the method 1000 can also be implemented at other the network devices. Only for the purpose of discussion, the method 1000 will be described with reference to FIG. 5 as performed by the network device 510.

At block 1010, the network device 510 determines whether a control and/or data channel to a terminal device is accessible on an unlicensed band. In some embodiments, the network device 510 may perform listen-before-talk (LBT) on the unlicensed band to determine whether the unlicensed band is occupied. If the unlicensed band is not occupied, the network device 510 may determine that the data channel is accessible. In some embodiments, the data channel may be a PDSCH. It should be noted that the data channel may be any suitable data channels.

At block 1020, if the control and/or data channel is determined to be accessible, the network device 510 determines, in a time slot, a position of a start symbol of transmission on the data channel. In some embodiments, the position may be at the boundary of the time slot. Alternatively, the position may be within the time slot. The term “transmission” used herein refers to a transmission from the network device to the terminal device, for example, one PDSCH and/or PDCCH transmission.

At block 1030, the network device generates, based on the position of the start symbol, the reference signal for the transmission. In some embodiments, the reference signal may be a DMRS. It should be noted that the data channel may be any suitable reference signals.

In some embodiments, the reference signal of data channel may be generated based on the actual index of the time slot and the actual indexes of the symbols occupied by the transmission. For example, if the network device 510 determines that the start symbol of the transmission is at the boundary of the time slot, the network device 510 may use the actual indexes (for example, from “0” to “13”) to generate the reference signal.

In some embodiments, the reference signal of data channel may be generated based on the relative index of the time slot and the relative indexes of the symbols of the transmission. For example, if the network device 510 determines that the start symbol of the transmission is not at the boundary of the time slot, the network device 510 may use the relative indexes to generate the reference signal. For example, the start symbol of the transmission may have an index of “4” in a time slot, the network device 510 ignore the index “4” and regard as the relative index of the start symbol to be “0” since it's the first symbol the transmission.

In some embodiments, if the transmission extends in two time slots (for example, the time slot n and the subsequent time slot n+1), the network device 510 may use the symbols left in the subsequent time slot n+1 to perform further transmission on the data channel. The term “further transmission” used herein refers to a different transmission from the network device to the terminal device, for example, one different PDSCH and/or PDCCH transmission. The number of the symbols for the further transmission may be determined based on the number of the transmission in the time slot n. For example, if the transmission occupies 10 symbols in the time slot n, it means that there are 4 symbols left in the further time slot n+1. The network device may generate reference signal sequence of data channel using time slot n for those 4 symbols which transmits in the further slot n+1. It should be noted that the number of symbols of the further transmission may be any suitable numbers.

At block 1040, the network device 510 transmits the reference signal on the control and/or data channel to the terminal device 520-1. In some embodiments, the network device 510 may transmit a synchronization signal block (SSB) on the data channel to the terminal device. In some embodiments, the data channel transmits with SSB on the first set of slot and the data channel transmits without SSB on the second set of slot. In some embodiments, the periods of monitoring the control channel in the first set of time slots and the second set of time slots may be configured differently.

For the data channel being between two slot boundaries, the slot boundary is also the boundary between allowed simultaneous transmission and none allowed simultaneous transmission and the SSB resources are rate matched and no signals are assumed by UE on that resources beyond the boundary. For aperiodic channel state information reference signals (CSI-RSs) on the data channel which the first symbol of PDSCH is not at the slot boundary, the relative index l and n which is the same to generate DMRS in PDSCH is used to generate CSI-RS signals. The CSI-RS resources may not be out of the ending of the data channel. For cross carrier scheduling, if the cross carrier data channel is failed to transmit at the indicated start symbol, the data channel may not transmit. In some embodiments, the data channel may rate matched around CORESET that possible for control channel transmission.

FIG. 11 illustrates a flowchart of an example method 1100 in accordance with embodiments of the present disclosure. It is to be understood that the method 1100 may include additional blocks not shown and/or may omit some blocks as shown, and the scope of the present disclosure is not limited in this regard. The method 1100 can be implemented at a terminal device, such as the terminal device 520-1 as shown in FIG. 5. Additionally or alternatively, the method 1000 can also be implemented at other the terminal devices. Only for the purpose of discussion, the method 1100 will be described with reference to FIG. 5 as performed by the terminal device 520-1.

At block 1110, the terminal device 520-1 receives transmission on the data channel from a network device. In some embodiments, the data channel may be a PDSCH. It should be noted that the data channel may be any suitable data channels.

At block 1120, the terminal device 520-1 obtains, from the transmission, a reference signal on the data channel. In some embodiments, the reference signal may be a DMRS. It should be noted that the data channel may be any suitable reference signals.

The reference signal is generated based on a position of a start symbol of the transmission in a time slot. In some embodiments, the position may be at the boundary of the time slot. Alternatively, the position may be within the time slot.

In some embodiments, the reference signal of the control channel may be generated based on the index of the time slot and the actual indexes of the symbols occupied by the transmission. For example, if the network device 510 determines that the start symbol of the transmission is at the boundary of the time slot, the network device 510 may use the actual indexes (for example, from “0” to “13”) to generate the reference signal.

In some embodiments, the reference signal of the control channel may be generated based on the actual index of the time slot and the relative indexes of the symbols of the transmission. For example, if the network device 510 determines that the start symbol of the transmission is not at the boundary of the time slot, the network device 510 may use the relative indexes to generate the reference signal. For example, the start symbol of the transmission may have an index of “4” in a time slot, the network device 510 ignore the index “4” and regard as the relative index of the start symbol to be “0” since it's the first symbol the transmission.

At block 1130, the terminal device 520-1 demodulates the transmission based on the reference signal. In some embodiments, the terminal device 520-1 may receive the SSB on the data channel.

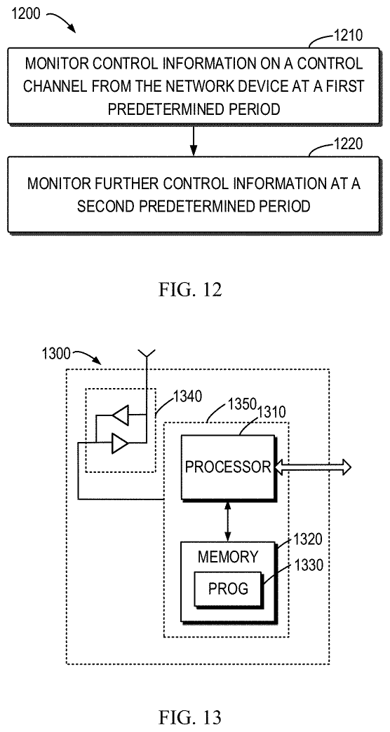

FIG. 12 illustrates a flowchart of an example method 1200 in accordance with embodiments of the present disclosure. It is to be understood that the method 1200 may include additional blocks not shown and/or may omit some blocks as shown, and the scope of the present disclosure is not limited in this regard. The method 1200 can be implemented at a network device, such as the terminal device 520-1 as shown in FIG. 5. Additionally or alternatively, the method 1200 can also be implemented at other the terminal devices. Only for the purpose of discussion, the method 1200 will be described with reference to FIG. 5 as performed by the terminal device 520-1.

At block 1210, the terminal device 520-1 monitors control information on a control channel from a network device at a first predetermined period. For example at the beginning, the terminal device 520-1 may monitor the control information more frequently. For example, the terminal device 520-1 may monitor the control information every two symbols.

At block 1220, the terminal device 520-1 monitors further control information on the control channel at a second predetermined period, if the control information is successfully detected. The second predetermined period is longer than the first predetermined period. For example, after the terminal device 520-1 detects the control information on the control channel, the terminal device 520-1 may monitor the further control information less frequently. For example, if the terminal device 520-1 detects the control information on the control channel and the control channel is at the time slot boundary, the terminal device 520-1 may monitor the further control information at the first symbol in the time slot. In this way, the energy of the terminal device 520-1 can be saved.

In some embodiments, the terminal device 520-1 may receive, from the network device, data channel scheduling information. The network device may monitor the further control information based on the received data channel scheduling information.

In some embodiments, the terminal device 520-1 may obtain, from the control information, the reference signal from the network device. The reference signal may be generated based on a position of a start symbol of transmission on the control channel in a time slot. For example, the symbol index for generating the reference signal may be regarded as “0” if the control channel begins within a slot. The index of the time slot for generating the reference signal is the time slot which the control channel is within. In some embodiments, the terminal device 520-1 may demodulate the control information on the control channel based on the reference signal.

In some embodiments, as shown in FIG. 9, if the terminal device 520-1 detects the control information and the control channel is not at the time slot boundary, the terminal device 520-1 may monitor the further control information based on data channel scheduling information. In some embodiments, the terminal device 520-1 may monitor the further control information at the end of the data channel.

It should be noted that the method 1000 and the method 1100 may be implemented in one embodiment. The method 1000 and the method 110 may also be implemented in different embodiments. Embodiments of the present disclosure are not limited in this aspect.

FIG. 13 is a simplified block diagram of a device 1300 that is suitable for implementing embodiments of the present disclosure. As shown, the device 1300 includes one or more processors 1310, one or more memories 1320 coupled to the processor(s) 1310, one or more transmitters and/or receivers (TX/RX) 1340 coupled to the processor 1310. The device 1300 may be implemented as the network device 510 and the terminal device 520.

The processor 1310 may be of any type suitable to the local technical network, and may include one or more of general purpose computers, special purpose computers, microprocessors, digital signal processors (DSPs) and processors based on multicore processor architecture, as non-limiting examples. The device 1300 may have multiple processors, such as an application specific integrated circuit chip that is slaved in time to a clock which synchronizes the main processor.

The memory 1320 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples.

The memory 1320 stores at least a part of a program 1330. The TX/RX 1740 is for bidirectional communications. The TX/RX 1340 has at least one antenna to facilitate communication, though in practice an Access Node mentioned in this application may have several ones. The communication interface may represent any interface that is necessary for communication with other network elements.

The program 1330 is assumed to include program instructions that, when executed by the associated processor 1310, enable the device 1300 to operate in accordance with the embodiments of the present disclosure, as discussed herein with reference to FIGS. 6 to 12. That is, embodiments of the present disclosure can be implemented by computer software executable by the processor 1310 of the device 1300, or by hardware, or by a combination of software and hardware.

Based on the above description, the skilled in the art would appreciate that the present disclosure may be embodied in an apparatus, a method, or a computer program product. In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flowcharts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof

While this specification contains many specific implementation details, these should not be construed as limitations on the scope of any disclosure or of what may be claimed, but rather as descriptions of features that may be specific to particular embodiments of particular disclosures. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Various modifications, adaptations to the foregoing exemplary embodiments of this disclosure may become apparent to those skilled in the relevant arts in view of the foregoing description, when read in conjunction with the accompanying drawings.

Any and all modifications will still fall within the scope of the non-limiting and exemplary embodiments of this disclosure. Furthermore, other embodiments of the disclosures set forth herein will come to mind to one skilled in the art to which these embodiments of the disclosure pertain having the benefit of the teachings presented in the foregoing descriptions and the associated drawings.

Therefore, it is to be understood that the embodiments of the disclosure are not to be limited to the specific embodiments disclosed and that modifications and other embodiments are intended to be included within the scope of the appended claims. Although specific terms are used herein, they are used in a generic and descriptive sense only and not for purpose of limitation.

1. A method implemented at a network device, comprising:
determining whether a control and/or data channel to a terminal device is accessible on an unlicensed band;
in response to determining that the control and/or data channel is accessible, determining, in a time slot, a position of a start symbol of transmission on the data channel;
generating, based on the position of the start symbol, a reference signal for the transmission; and
transmitting the reference signal to the terminal device.

2. The method of claim 1, wherein the position indicates that the start symbol is at a boundary of the time slot, and wherein generating the reference signal for the transmission comprising:
determining an index of the time slot;
determining actual indexes of symbols occupied by the transmission in the time slot; and
generating the reference signal based on the index of the time slot and the indices of the symbols.

3. The method of claim 1, wherein the position indicates that the start symbol of the data channel is within the time slot, wherein generating the reference signal for the transmission comprising:
determining the relative index of the time slot;
determining relative indexes of symbols of the transmission, the relative indexes indicating a position of one symbol being in the symbols of the transmission; and
generating the reference signal of data channel based on the relative index of the time slot and the relative indexes of the symbols.

4. The method of claim 3, further comprising:
in response to determining that the transmission being in the time slot n and a subsequent time slot n+1,
determining the number of symbols of a further transmission in the subsequent time slot n+1 as the relative index n , wherein n is an integer number.

5. The method of claim 1, further comprising:
transmitting a synchronization signal block (SSB) on the data channel to the terminal device.

6. The method of claim 5, wherein the data channel transmits with SSB on a first set of time slots, and the data channel transmits without SSB on a second set of time slots.

7. The method of claim 1, wherein the position indicates that the start symbol of the control channel is within the time slot, wherein generating the reference signal for the transmission comprising:
determining an actual index of the time slot;
determining relative indexes of symbols of the transmission; and
generating the reference signal of the control channel in association with the actual index of the time slot and the relative indexes of symbols of the transmission.

8. The method of claim 1, wherein determining whether the control and/or data channel to the terminal device is accessible on the unlicensed band comprises:
performing listen-before-talk (LBT) on the unlicensed band; and
determining whether the control and/or data channel to the terminal device is accessible based on a result of the LBT.

9. The method of claim 1, wherein the data channel is a physical downlink shared channel (PDSCH), the control channel is a physical downlink control channel (PDCCH), and the reference signal is a demodulation reference signal (DMRS).

10-11. (canceled)

12. A method implemented at a terminal device, comprising:
receiving transmission on a control and/or data channel from a network device;
obtaining, from the transmission, a reference signal on the control and/or data channel, the reference signal being generated based on a position of a start symbol of the transmission in a time slot; and
demodulating the transmission based on the reference signal.

13. The method of claim 12, wherein the reference signal is generated based on an index of the time slot and actual indexes of symbols of the transmission in the time slot.

14. The method of claim 12, wherein the reference signal is generated based on an index of the time slot and relative indexes of symbols of the transmission, the relative indexes indicating a position of one symbol being in the symbols of the transmission.

15. The method of claim 12, further comprising:
receiving a synchronization signal block (SSB) on the data channel.

16. The method of claim 12, further comprising:
receiving downlink control information (DCI), the DCI being generated based on an index of the time slot.

17. The method of claim 12, wherein the data channel is a physical downlink shared channel (PDSCH), the control channel is a physical downlink control channel (PDCCH), and the reference signal is a demodulation reference signal (DMRS).

18-19. (canceled)

20. A method implemented at a terminal device, comprising:
monitoring control information on a control channel from a network device at a first predetermined period; and
in response to successfully detecting the control information at slot boundary, monitoring further control information on the control channel at a second predetermined period, the second predetermined period being longer than the first predetermined period.

21. The method of claim 20, further comprising:
receiving, from the network device, information comprising the first predetermined period and the second predetermined period.

22. The method of claim 20, wherein monitoring the further control information comprises:
receiving, from the network device, data channel scheduling information;
in response to detecting the control information being within a time slot, monitoring the further control information based on the received data channel scheduling information.

23. The method of claim 20, wherein monitoring the further control information comprises:
detecting, from the network device, common downlink control information;
in response to detecting the common downlink control information being within a time slot for the first time, monitoring the further control information based on a predefined symbol after the first symbol containing the common downlink control information; or
in response to detecting the common downlink control information being within a time slot not for the first time, monitoring the further control information on a next slot boundary.

24-29. (canceled)
